(19) United States
(12) Patent Application Publication
(10) Pub. No.: US 2008/0101091 A1
(43) Pub. Date: May 1, 2008

(54) Diffusion film, manufacturing method thereof and a backlight module with the diffusion film

(76) Inventor: Yu-Sheng Teng, Lujhou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/590,887

(22) Filed: Nov. 1, 2006

(51) Int. Cl. F21V 7/04

(52) U.S. Cl. 362/627

(57) ABSTRACT

A diffusion film consists of a transparent film layer, a coating layer on one side of the transparent film layer, and a stickiness prevention layer on the other side of the transparent film layer; to make the stickiness prevention layer, first the transparent film layer is coated with a layer of viscous resin, and next a roller, which has a raised pattern on its surface, is rolled over the viscous resin coating for the coating to have raised and sunken portions arranged in regularly repeated manner on its surface, and the viscous resin coating is fixed into shape; the diffusion film is positioned such that the stickiness-prevention layer touches the light guide plate for preventing the diffusion film and the light guide plate from sticking together and preventing optical interference; consequently, the backlight module has a uniform light.

### BACKGROUND OF THE INVENTION

1. Field of the Invention

The present invention relates to a diffusion film, more particularly one, which has a stickiness prevention layer made according to a method comprising coating step, embossing step, and shape-fixing step, thus having raised and sunken portions arranged in a regularly repeated manner.

2. Brief Description of the Prior Art

LCD has relatively small thickness and is light in weight. Highly efficient light sources have to be developed for making large-sized, colorful, thin, light and low power-loss LCD possible. And, a backlight module for improving visibility is placed behind the liquid crystal display panel so that satisfactory visibility is ensured in circumstances where the brightness of surroundings is insufficient.

A backlight module includes a light source portion, a light guide plate, diffusion films and brightness enhancement films. Backlight modules are classified into three types according to the disposition of their light source portions: [1] edge-light type backlight modules, in which the light source portions are disposed on lateral sides of the light guide plates, and which have relatively small thickness, and are suitable for use on laptops; [2] directly-under-light (bottom light) type backlight modules, in which the light source portions are disposed under the light guide plates, and which are mostly used in a stationary product, such as a desktop LCD or an LC TV as it has a heavy appearance; a directly-under-light (bottom light) type backlight module usually has several light sources under its light guide plate; [3] hollow light type backlight modules, which are suitable for use on large-sized, highly bright and highly efficient LCD.

No matter which type of backlight modules are used, there will be less light on those portions of the light guide plates that are farther away from the light source portions, and more light on those portions of the light guide plates that are nearer to the light source portions. Referring to FIG. 6, a currently existing backlight module includes a light guide plate 3, and a diffusion film 4 positioned on the light guide plate 3 for homogenizing light passing from the light guide plate 3 and eliminating mesh point phenomenon. The diffusion film 4 has a stickiness prevention layer 41, which touches the light guide plate 3 for preventing the diffusion film 4 and the light guide plate 3 from sticking together. In manufacturing, chip particulates of different diameters are added to binder resin, and the binder resin is applied over the diffusion film 4 to form the stickiness prevention layer 41. Because of the chip particulates, the stickiness prevention layer 41 has raised and sunken portions on its surface, the diffusion film 4 can't stick to the light guide plate 3. However, because the chip particulates have different diameters, the diffusion film is prone to have larger chip particulates gathering on certain portions thereof, and smaller ones on other portions. Consequently, the backlight module doesn't have uniform light source. In addition, the chip particulates will cause significant increase to the material and management cost.

### SUMMARY OF THE INVENTION

It is a main object of the invention to provide an improvement on a diffusion film to overcome the above-mentioned problems.

The diffusion film of the present invention consists of a transparent film layer, a coating layer on one side of the transparent film layer, and a stickiness prevention layer on the other side of the transparent film layer. To make the stickiness prevention layer, first the transparent film layer is coated with a layer of viscous binder, and next a roller, which has a raised pattern on its surface, is rolled over the viscous binder coating for the coating to be formed with raised and sunken portions arranged in regularly repeated manner on its surface, and finally the binder coating is fixed into shape. When the diffusion film is positioned on a light guide plate, the stickiness-prevention layer will touch the light guide plate for preventing the diffusion film and the light guide plate from sticking together and preventing optical interference. Consequently, the backlight module has a uniform light.

### BRIEF DESCRIPTION OF THE DRAWINGS

The present invention will be better understood by referring to the accompanying drawings, wherein:

FIG. 1 is a flow chart of the present invention,

FIG. 2 is a sectional view of a diffusion film, taken after the first step of the manufacturing method is carried out,

FIG. 3 is a sectional view of a diffusion film, taken when the second step of the manufacturing method is being carried out,

FIG. 4 is a sectional view of a diffusion film, taken after the third step of the manufacturing method is carried out,

FIG. 5 is a sectional view of the diffusion film fitted on a backlight module, and

FIG. 6 is a sectional view of the prior art.

### DETAILED DESCRIPTION OF THE PREFERRED EMBODIMENTS

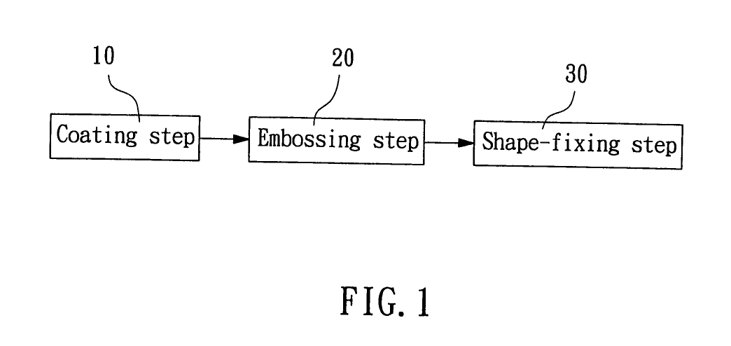

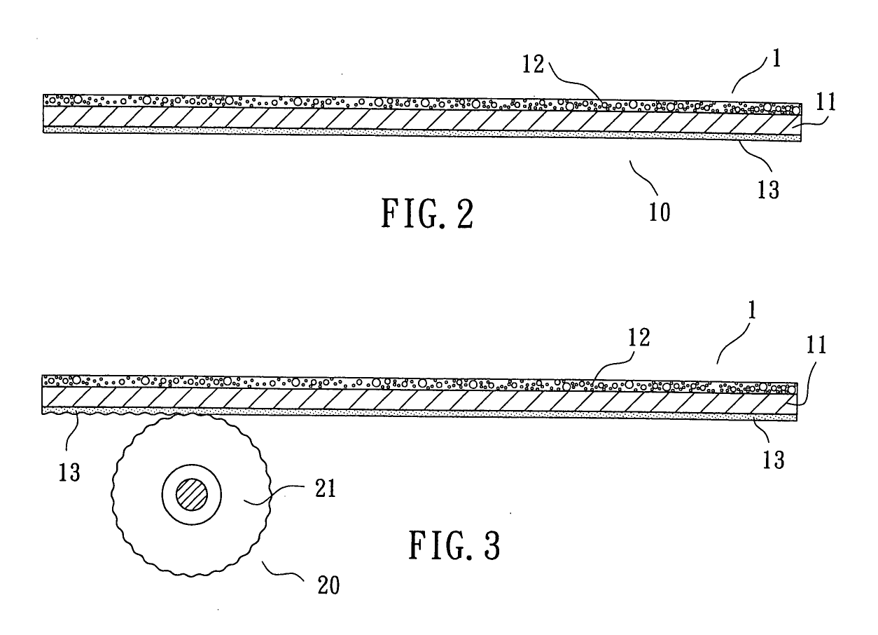

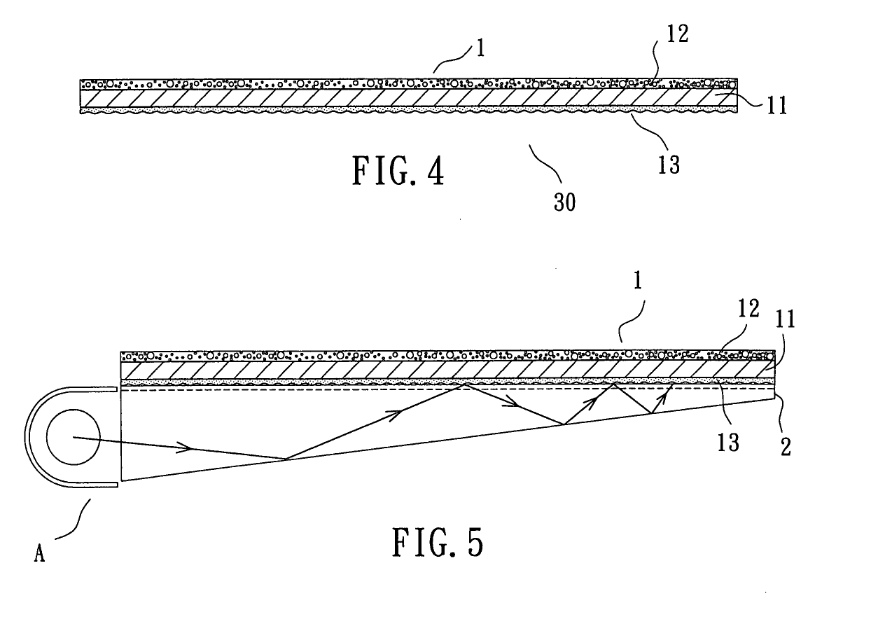

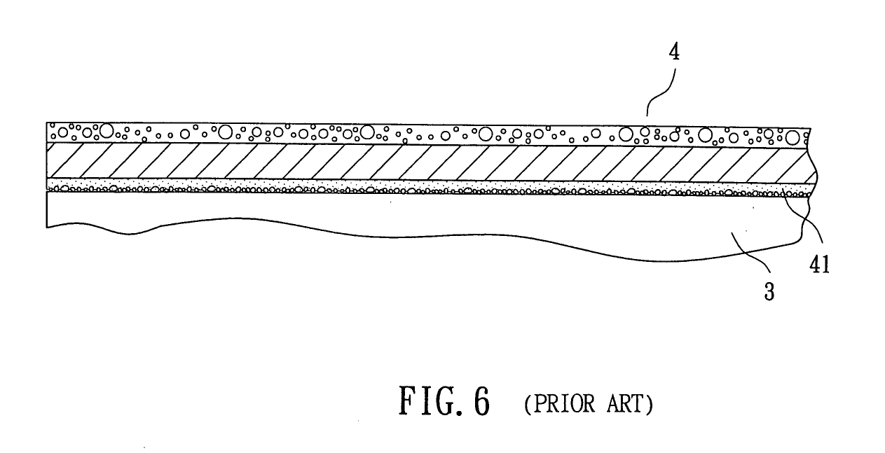

Referring to FIGS. 1 to 5, a preferred embodiment 1 of a diffusion film of the present invention consists of a transparent film layer 11, a coating layer 12, and a stickiness-prevention layer 13. The coating layer 12 covers an upper side of the transparent film layer 11, and comprises viscous binder, and spherical powders added to the viscous binder, which spherical powders are 1 to 50 μm in diameter, 1.3 to 2.0 in reflection ratio, and which can be acryl, Polystyrene or silicone ones. The stickiness-prevention layer 13 is positioned on a lower side of the transparent film layer 11. The stickiness-prevention layer 13 is made by means of coating, embossing, and shape-fixing steps, which are described as followings:

1. Coating step 10: the transparent film layer 11, which is made of PET, is coated with a layer of viscous resin; antistatic agent is preferably added to the viscous resin so that the stickiness-prevention layer 13 has better antistatic effect;

2. Embossing step 20: a roller 21, which has a raised pattern on its surface, is rolled over the viscous resin coated on the transparent film layer 11 so that the viscous resin has a raised pattern on its surface, which has a pre-designed height; in other words, the stickiness-prevention layer 13 has raised and sunken portions on its surface, and the raised portions have the designed pattern;

3. Shape-fixing step 30: the raised pattern on the viscous resin is fixed into shape by means of UV or heat energy.

The transparent film layer 11 of the diffusion film 1 is coated with a layer of resin on the lower side. Next, before the coating resin becomes solid, it is pressed by means of a roller, which has a raised pattern on it surface; thus, the stickiness-prevention layer 13 is made with a regularly repeated arrangement of raised and sunken portions on its surface. The diffusion film 1 is positioned such that the stickiness-prevention layer 13 touches a light guide plate 2; because the stickiness-prevention layer 13 has a raised pattern on its surface, there will be antistatic tiny stickiness-prevention spaces between the diffusion film 1 and the light guide plate 2 for preventing the diffusion film 1 and the light guide plate 2 from sticking together when the diffusion film 1 and the light guide plate 2 are positioned together to comprise a backlight module (A). Consequently, the backlight module (A) has a uniform light source.

Raised and sunken portions of the stickiness-prevention layer 13 can be arranged in a regularly repeated manner, a continuous manner or any other particular manner. The raised pattern of the stickiness-prevention layer 13 further can produce a particular light diffusing effect or light gathering effect. The main purpose of the stickiness-prevention layer 13 is to prevent production of static electricity, which will cause the diffusion film 1 and the light guide plate 2 to stick together. Therefore, it is preferable for antistatic agent to be added to the viscous resin material of the stickiness-prevention layer 13.

Furthermore, it is preferable to add SiO2, which is 5 to 50 nm in diameter, to the coating layer 12 for increasing heat-resistibility of the diffusion film 1. The resin used in the coating layer 12 can be PMMA resin, Polyester resin or UV-curable resin.

In summary, the diffusion film of the present invention has a stickiness-prevention layer, which has a raised pattern formed by means of embossing roller; thus, the diffusion film and the light guide plate of the backlight module won't stick together. Furthermore, because the stickiness-prevention layer of the diffusion film has raised and sunken portions arranged in a regularly repeated manner, static electricity and optical interference will be prevented when the diffusion film is positioned on the light guide plate. Consequently, light from the light guide plate 2 is uniform. Because there is no need to use chip particulates in the material, it takes relatively low material, labor and management cost to manufacture the diffusion film of the present invention.

What is claimed is:

1. A diffusion film, comprising
a transparent film layer,
a coating layer covering an upper side of the transparent film layer, and
a stickiness-prevention layer on a lower side of the transparent film layer; the stickiness-prevention layer being embossed to have a raised pattern formed thereon, thus having raised and sunken portions; said raised portions having a repeat pattern.

2. The diffusion film as recited in claim 1, wherein the raised and sunken portions of the stickiness-prevention layer are arranged in a regularly repeated manner.

3. The diffusion film as recited in claim 1, wherein the stickiness-prevention layer has antistatic agent added thereto.

4. A method for manufacturing a diffusion film, which comprises
a transparent film layer,
a coating layer covering an upper side of said transparent film layer, and
a stickiness-prevention layer on a lower side of said transparent film layer;
said stickiness-prevention layer being made by means of a method comprising following steps:
(a) coating step: said lower side of said transparent film layer is coated with a layer of viscous resin;
(b) embossing step: a roller, which has a raised pattern on a surface, is rolled over said viscous resin so that said viscous resin has a raised pattern on a surface, thus having raised and sunken portions; and
(c) shape-fixing step: said raised pattern on said viscous resin is fixed into shape by means of UV and heat energy.

5. The method for manufacturing a diffusion film as recited in claim 4, wherein the raised and sunken portions of the stickiness-prevention layer are arranged in a regularly repeated manner.

6. The diffusion film as recited in claim 4, wherein said viscous resin has antistatic agent added thereto.

7. The diffusion film as recited in claim 4, wherein said coating layer has spherical powders added thereto, which powders are 1 to 50 μm in diameter.

8. The diffusion film as recited in claim 4, wherein said coating layer has SiO2 having a diameter of 5 to 50 nm added thereto for increasing heat-resistibility of the diffusion film.

9. The diffusion film as recited in claim 4, wherein said coating layer is made of PMMA binder.

10. The diffusion film as recited in claim 4, wherein said coating layer is made of Polyester binder.

11. The diffusion film as recited in claim 4, wherein said coating layer is made of UV-curable binder.

12. A backlight module, comprising
(a) a light source;
(b) a light guide plate; and
(c) a diffusion film, said diffusion film comprising
a transparent film layer,
a coating layer covering an upper side of said transparent film layer, and
a stickiness-prevention layer on a lower side of said transparent film layer;
said stickiness-prevention layer being made by means of a method comprising following steps:
(e) coating step: said lower side of said transparent film layer is coated with a layer of viscous binder;
(f) embossing step: a roller, which has a raised pattern on a surface, is rolled over said viscous resin so that said viscous resin has a raised pattern on a surface, thus having raised and sunken portions; said raised portions having a repeat pattern; and
(g) shape-fixing step: said raised pattern on said viscous resin is fixed into shape.

13. The method for manufacturing a diffusion film as recited in claim 12, wherein the raised and sunken portions of the stickiness-prevention layer are arranged in a regularly repeated manner.

14. The diffusion film as recited in claim 12, wherein said viscous resin used in said coating step has antistatic agent added thereto.

15. The diffusion film as recited in claim 12, wherein said coating layer has spherical powders added thereto, which powders are 1 to 50 μm in diameter.

16. The diffusion film as recited in claim 12, wherein said coating layer has SiO2 having a diameter of 5 to 50 nm added thereto for increasing heat-resistibility of the diffusion film.

17. The diffusion film as recited in claim 12, wherein said coating layer is made of PMMA binder.

18. The diffusion film as recited in claim 12, wherein said coating layer is made of Polyester binder.

19. The diffusion film as recited in claim 12, wherein said coating layer is made of UV-curable binder.
